(19) United States
(12) Patent Application Publication
(10) Pub. No.: US 2006/0155447 A1
(43) Pub. Date: Jul. 13, 2006

(54) Control system for a load-carrying vehicle

(75) Inventors: Gary Dean Uken, Monticello, IL (US); Robert Doyle Roley, Windsor, IL (US)

Correspondence Address: CATERPILLAR/FINNEGAN, HENDERSON, L.L.P., 901 New York Avenue, WASHINGTON, DC, 20001-4413, US

(73) Assignee: Caterpillar Inc.

(21) Appl. No.: 11/030,059

(22) Filed: Jan. 7, 2005

(51) Int. Cl. G06F 19/00

(52) U.S. Cl. 701/50; 701/51

(57) ABSTRACT

A control system for a load-carrying vehicle includes a sensor configured to measure a parameter of the vehicle and communicate a sensor signal indicative of the measured parameter. The control system also includes a control module configured to receive the sensor signal from the sensor and determine an appropriate engine power level based on the sensor signal.

### TECHNICAL FIELD

This disclosure is directed to a control system for a load-carrying vehicle and, more particularly, to a control system for improving performance of a load-carrying vehicle.

### BACKGROUND

Some vehicles, such as load-carrying trucks, may be used to transport heavy payloads up and down steep grades, such as those that may be found at open-pit mines. When traveling down a grade, an operator may select a gear that will help retard the truck speed, without an excessive reliance on the brakes. If the operator chooses a gear that is too high, the truck may accelerate, requiring the operator to excessively rely upon the brakes. If the operator chooses a gear that is too low, the gear may unduly retard the truck movement, causing the truck to travel down the grade in a slow, inefficient manner.

To aid the operator in selecting a gear, some vehicles include a chart within the machine's operator cab that identifies a specific gear for a specific grade range. For example, if the grade is between 8% and 10%, the chart may identify the third gear as being the most efficient. Referencing a chart for the gear, however, can become tedious where the terrain is hilly. These charts may be developed based on a broad range of conditions that are not optimized for changes in variables that effect braking capacity, such as climate.

Some load-carrying trucks are also designed with high horsepower engines that enable the truck to carry its payload up a grade. However, the same high horsepower may not be necessary to move the truck in areas of less resistance, such as when traveling across level ground or in uphill conditions where the truck carries a partial payload or no payload. Some known systems allow an operator to manually select a fuel mode on the vehicle between a full-power mode, utilizing the maximum horsepower of the truck, and an economy mode, utilizing a lower horsepower. In known systems, an operator must manually switch between fuel modes. Because of this, the fuel mode selected by the operator may not always be the most efficient available mode. In some instances, the operator may completely neglect to switch modes when appropriate, continuously operating the vehicle in a single mode, such as the full-power mode, even when on level ground. This may result in wasted fuel, unnecessary exhaust emissions, and higher operating expenses.

U.S. Pat. No. 4,564,906 to Stephan et al. discloses one system for gear shifting in relation to a vehicle load. The '906 patent discloses measuring sensors that measure engine speed, engine torque, and speed of a vehicle. A driver may manually input a mass value through a switch having selectable ranges, such as 0, ½, and 1. The value is sent to a controller that produces gear shifting signals when the signals are above or below a predetermined value range. However, in the system disclosed in the '906 patent, an operator is required to manually operate the switch, thereby requiring the operator to maintain a knowledge of load amount. Such a system may become tiresome and may not be fully utilized by an operator.

The present disclosure is directed to control system that overcomes one or more of the deficiencies of the prior art.

### SUMMARY OF THE INVENTION

In one exemplary aspect, a control system for a load-carrying vehicle is disclosed. The control system may include a sensor configured to measure a parameter of the vehicle and communicate a sensor signal indicative of the measured parameter. The control system also may include a control module configured to receive the sensor signal from the sensor and determine an appropriate engine power level based on the sensor signal.

In another exemplary aspect, a method for controlling a load-carrying vehicle with a control system is disclosed. The method may include measuring a parameter of the vehicle and communicating a sensor signal indicative of the measured parameter. The sensor signal may be received at a control module and an appropriate engine power level may be determined with the control module based on the sensor signal.

### BRIEF DESCRIPTION OF THE DRAWINGS

FIG. 1 is a diagrammatic illustration of an exemplary vehicle.

FIG. 2 is a block diagram showing an exemplary control system.

FIG. 3 is a graph showing exemplary engine power levels.

FIG. 4 is a flow chart of an exemplary method for controlling a load-carrying vehicle.

FIG. 5 is another flow chart of an exemplary method for controlling the load-carrying vehicle.

### DETAILED DESCRIPTION

Reference will now be made in detail to exemplary embodiments that are illustrated in the accompanying drawings. Wherever possible, the same reference numbers will be used throughout the drawings to refer to the same or like parts.

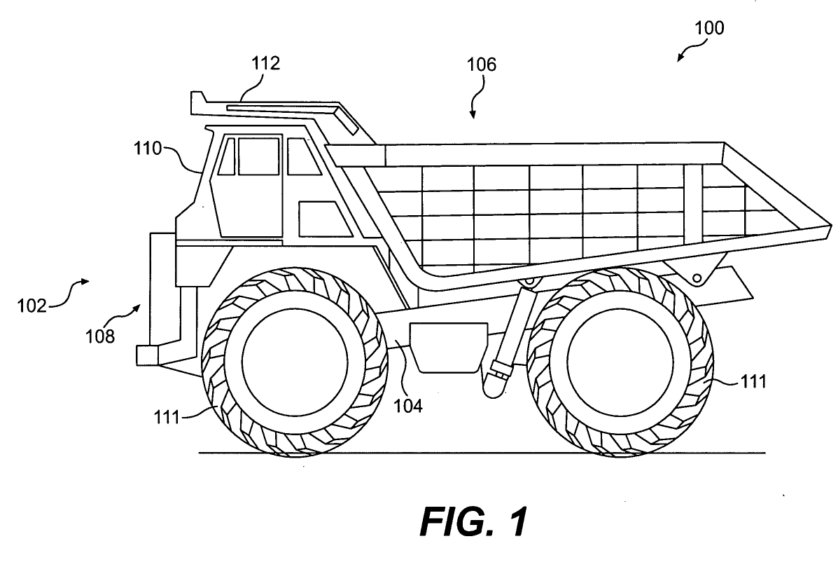

An exemplary embodiment of a load-carrying vehicle 100 is illustrated in FIG. 1. The vehicle 100 may be a work machine, such as an off-highway truck, as shown, or other vehicle, such as an on-highway truck, an articulated truck, an off-highway tractor, or other vehicle. The exemplary vehicle 100 may include a front end 102, a frame 104, and a payload container 106. The front end 102 may include an engine compartment 108 and an operator's cab 110. The engine compartment 108 may house an engine, a transmission, and/or other components used to power the vehicle 100. The operator's cab 110 may include controls for operating and driving the vehicle 100, including a throttle device, such as, for example, a foot-operated pedal. The engine in the engine compartment 108 drives wheels 111 attached to the frame 104, in a manner known in the art.

The payload container 106 is attached to and supported by the frame 104. As a part of the payload container 106, a canopy 112 may extend over the operator's cab 110. The canopy 112 may be configured to provide protection to the operator's cab 110 from earth, debris, and other material that may be dumped into the payload container 106, including on the canopy 112 itself.

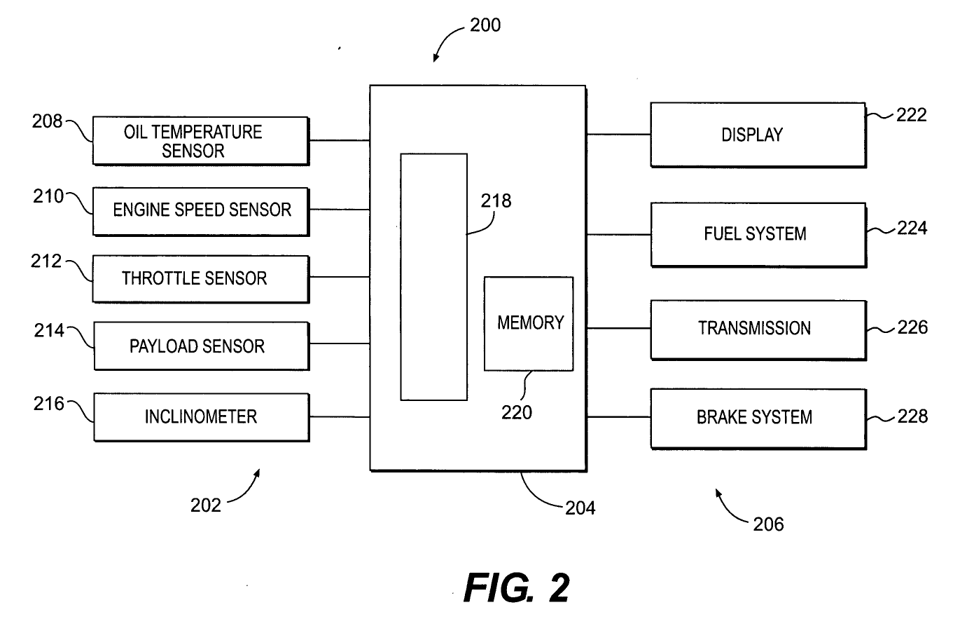

FIG. 2 shows a control system 200 that may be operably associated with the vehicle 100. The control system 200 may include a series of sensors 202, a control module 204, and machine components 206. In this embodiment, the series of sensors 202 may be configured to measure vehicle parameters and may include an oil temperature sensor 208, an engine speed sensor 210, a throttle sensor 212, a payload sensor 214, and a grade detector, such as an inclinometer 216. These sensors may be in electrical communication with, and may be configured to send sensor signals indicative of the measured parameters to the control module 204, which may represent one or more control modules. The control module 204 may receive communication signals from one or more of the series of sensors 202, and may generate a command signal that may be communicated to any of the components 206 of the vehicle 100. The components 206 of the vehicle may include, for example a display 222, a fuel system 224, a transmission 226, and a brake system 228. Naturally, other components also may be included.

The oil temperature sensor 208 may be configured to monitor a temperature of braking system oil on the vehicle 100. The oil temperature sensor 208 also may be configured to communicate a temperature signal representative of the temperature to the control module 204. In one exemplary embodiment, the oil temperature sensor 208 may be disposed within an oil pan or may monitor the temperature of oil at the brakes themselves.

The engine speed sensor 210 may be operably associated with the engine of the vehicle 100 and may be configured to detect the engine speed. In one exemplary embodiment, the engine speed sensor 210 is configured to measure an rpm of an input shaft or cam shaft. In another exemplary embodiment, the engine speed sensor is configured to measure a shaft speed within a transmission. The sensor may be associated with other components that allow measuring or determining of the engine speed.

The throttle sensor 212 may be associated with an input device in the vehicle 100. In some exemplary embodiments, the input device is a foot-operated pedal on a floor in the operator's cab 110 of the vehicle 100, or alternatively, a hand-operated lever. The throttle sensor 212 may be, for example, a position or rotary sensor that monitors the position of the pedal. It should be noted that the throttle sensor 212 may be associated with any throttle on the vehicle, including a lever, dial, or other throttle device. Detecting an input from the operator, the throttle sensor 212 may communicate a throttle signal to the control module 204.

The payload sensor 214 may be associated with the vehicle 100 in a manner to detect the weight of the payload being carried by the vehicle 100. In one exemplary embodiment, the payload sensor 214 may include several sensors, such as a torque sensor, a weight sensor, a pressure sensor, and/or other sensors configured as known in the art to monitor the payload weight. In one embodiment, the payload sensor 214 may indirectly monitor the payload by monitoring the pressure of struts in a suspension system. Other known systems may also be used. The payload sensor 214 may be configured to generate and communicate a payload signal to the control module 204. In one exemplary embodiment, the payload sensor continuously detects the weight of the payload.

The inclinometer 216 may be the grade detector associated with the vehicle 100 and may be configured to continuously detect an inclination of the vehicle 100. In one exemplary embodiment, the inclinometer 216 is associated with or fixedly connected to the frame 104 of the vehicle 100. However, the inclinometer 216 may be connected on any stable surface of the vehicle 100. In one exemplary embodiment, the inclinometer 216 is configured to detect incline in any direction, including a forward-aft direction. The inclinometer 216 may be configured to generate and send an incline signal to the control module 204. It should be noted that although this disclosure describes the inclinometer as the grade detector, other grade detectors may be used. In one exemplary embodiment, the grade detector includes two GPS receivers, with one stationed at each end of the vehicle 100. By knowing the positional difference of the receivers, the inclination of the vehicle may be calculated. Other grade detectors also may be used.

The control module 204 may include a processor 218 and a memory component 220. The processor 218 may be configured to receive signals from the series of sensors 202, process information stored in the memory component 220, and generate a command signal to be sent to one or more of the components 206. The memory component 220 may be configured to store processes, data, and/or additional information, including computer programs, such as computer code, that may be used to process the signals from the series of sensors 202.

The memory component 220 may contain data representative of a series of engine power levels that may be configured to control a power ratio between the throttle signal, based on the throttle position, and the output power from the engine of the vehicle 100, over a range of the throttle signal. In one exemplary embodiment, the power ratio may be controlled by regulating the amount of fuel that may be sent to the engine, thereby controlling the amount of fuel burned per engine cycle and, therefore, the amount of horsepower generated by the engine.

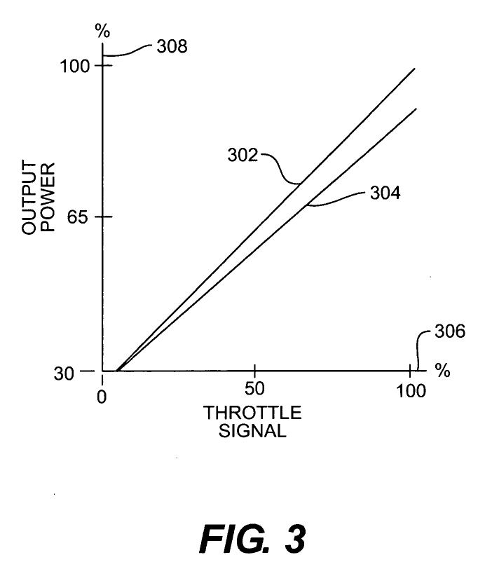

FIG. 3 shows an exemplary graph 300 depicting an exemplary first engine power level 302 and an exemplary second engine power level 304. The graph 300 is defined by a throttle signal axis 306 and an output power axis 308. The throttle signal axis 306 defines a range of possible throttle signals, while the output power axis 308 shows one exemplary range of possible output power. It should be noted that the throttle signal may be determined based upon the position of the throttle input device. In this exemplary embodiment, the first engine power level 302 defines a power ratio over the range of possible throttle signals and is configured to operate the engine at 100% of the available output power at the maximum throttle signal. The second engine power level 304 defines a power ratio over the range of possible throttle signals and is configured to operate the engine at less than 100% of the available output power at the maximum throttle signal, such as, for example, a maximum of about 90% of the output power. Accordingly, for a single throttle signal, based on a single throttle position, the amount of power output from the engine may differ depending on the selected engine power level. In this exemplary embodiment, the engine power levels 306, 308 are shown as straight lines. However, the engine power levels may be configured to provide any desired relationship between the throttle signal, based on the throttle position and the output power. Accordingly, the power ratio may be defined by engine power levels having non-linear relationships. The first and second engine power levels 302, 304 shown in FIG. 3 provide a different power ratio over substantially the complete range of possible throttle signals. However, it should be noted that the engine power levels may provide a different power ratio for the same input over less than the complete range of possible throttle signals. For example, in one exemplary embodiment, two different engine power levels may provide different power ratios for more than half the range of possible throttle signals.

The engine power level data may also include data for selecting the appropriate level based on the terrain where the vehicle 100 is operating. For example, when traveling uphill, as indicated by the inclinometer 216, the appropriate engine power level may allow the engine to operate at 100% of the available horsepower, as shown by the first engine power level 302. In contrast, when traveling on relatively level ground or downhill, the appropriate engine power level may only allow the engine to operate at 90% of the available horsepower, as shown by the second engine power level 304. The engine power levels may be, for example, look-up tables stored within the memory component 220 and, for a given series of signals from the sensors 202, the control module 204 may identify and select an appropriate engine power level for use. It should be noted that although only two engine power levels are shown in FIG. 3, the memory component 220 may include any number of levels that may be used to control the power output.

In addition, the memory component 220 may contain data representative of a running gear on the vehicle 100. The running gear information may include data for selecting an appropriate gear based on the terrain where the vehicle is operating. For example, one factor that may be considered for determining the appropriate gear may be a grade being traveled by the vehicle 100, as measured by the inclinometer 216. The running gear data may be, for example, a look-up table where, for a given signal or a given series of signals, an appropriate gear is identified and selected. In another exemplary embodiment, the running gear data is an algorithm configured to detect and output a specific gear based on the inputs from the series of sensors 202.

Based on information from one or more of the sensors 202 and the information stored in the memory component 220, the control module 204 may be configured to generate a command signal that may be communicated to one or more of the machine components 206. In the exemplary embodiment described, the command signal may be a display signal, a fuel system signal, a transmission signal, and/or a brake system signal that may be communicated to the display 222, the fuel system 224, the transmission 226, and/or the brake system 228, respectively.

The display 222 may be disposed within the operator's cab 110 of the vehicle 100 for viewing by an operator. The display 222 may be configured to convey information to the operator, such as, for example, information detected by the series of sensors 202. In one exemplary embodiment, the display 222 is configured to convey information received from the inclinometer 216. In this embodiment, the display 222 may convey information regarding the percent grade being traveled by the vehicle 100. The display 222 may also be configured to convey information regarding the current payload based on information received from the payload sensor 214. It may also convey information such as the throttle amount, the current engine speed, and/or the oil temperature, as detected by the respective sensors.

The fuel system 224 may be operably associated with the engine and may allow specific control of the amount of fuel used within the fuel system. In one exemplary embodiment, the fuel system 224 may include injectors that are regulated to control the fuel amounts injected to the engine. By controlling the fuel amounts, the horsepower and the amount of fuel burned may be regulated. The fuel system 224 may receive the fuel signal from the control module 204.

The transmission 226 may be housed within the engine compartment 108 on the vehicle 100 and may include different operating gears, as known in the art. The transmission 226 may be configured to shift to an appropriate gear based on the transmission signal from the control module 204. The transmission signal may be generated based upon signals from the inclinometer 216, the payload sensor 214, the engine speed sensor 210, and/or the oil temperature sensor 208, among others.

The brake system 228 may be configured to apply brake resistance to frictionally retard movement of the vehicle 100 over the ground. In one exemplary embodiment, the brake system 228 may automatically control the braking resistance to limit or maintain the engine speed, as monitored by the engine speed sensor 210, to a pre-established speed. Accordingly, the brake system 228 may be particularly useful when traveling downhill, as determined by the inclinometer 216.

In one exemplary embodiment, the control module 204 may be configured to adjust shift points of the transmission 226. As used herein, a shift point is an rpm value or range where the transmission 226 may shift from one gear to another. Based on the engine speed as detected by the engine speed sensor 210, the inclination of the vehicle 100 as detected by the inclinometer 216, and/or the payload of the vehicle 100 as detected by the payload sensor, the control module 204 may be configured to adjust the shift point between adjacent gears to a pre-established rpm. For example, in one exemplary embodiment, the shift point for shifting between a 3rd and a 4th gear of the vehicle may be about 1800 rpm when traveling across moderately level ground, as detected by the inclinometer. However, when the control module 204 determines that the vehicle 100 is traveling downhill, the control module 204 may adjust the shift point to about 1650 rpm. This may result in better fuel economy by allowing the gears to shift at a relatively lower rpm when high power is not necessary, such as when traveling downhill. When the control module 204 determines that the vehicle 100 is traveling uphill, the control module 204 may adjust the shift point to about 1950 rpm. This may provide higher power during the shift by allowing the gears to shift at a relatively higher rpm when high power is necessary, such as when traveling uphill or with a heavy payload.

In addition to inclination of the vehicle 100, the weight of a payload of the vehicle 100 also may be used to adjust the shift point. For example, when the vehicle 100 carries a heavy payload, as detected by the payload sensor 214, the control module 204 may adjust the shift point to a relatively higher rpm when traveling uphill and a relatively lower rpm when traveling downhill. In one exemplary embodiment, the adjustment to the shift point may be stored on the memory component 220 as a lookup table. However, other methods for determining the shift point may be used. Adjusting the shift point may provide smooth transitions between gears.

Based on the information detected by one or more of the sensors 202, the control module 204 may be configured to determine an appropriate engine power level, an appropriate running gear for the vehicle 100, and/or an appropriate shift point. The control module 204 may then control one or more of the machine components 206 based on the appropriate engine power level, running gear, and/or shift point. By detecting the grade that the vehicle is operating on, and by detecting the payload, the vehicle 100 may be operated in a relatively efficient manner.

### INDUSTRIAL APPLICABILITY

The control system disclosed herein may aid in automatically recognizing and selecting an appropriate running gear and may aid in automatically recognizing and implementing an appropriate engine power level for the vehicle 100. Recognizing and selecting an appropriate running gear may provide efficiency when traveling down a grade with a payload, thereby resulting in cost savings. In addition, automatically recognizing and implementing an appropriate engine power level may conserve fuel, lower unnecessary emissions, and reduce operating costs.

By receiving and considering signals from one or more of the sensors 202, the control module 204 may determine which operating gear is appropriate during operation of the vehicle. For example, one gear may be selected when traveling across level ground, while another lower gear may be selected to retard a descent down a grade, without overly limiting the descent speed. Furthermore, by receiving and considering signals from the series of sensors 202, the control module 204 may determine when the vehicle 100 should operate at full horsepower, such as when climbing hills, and may also determine when less-than-full horsepower is needed, such as when traveling over flat ground or down a hill. The control module 204 may then select an appropriate engine power level from the engine power levels stored within the memory component 220.

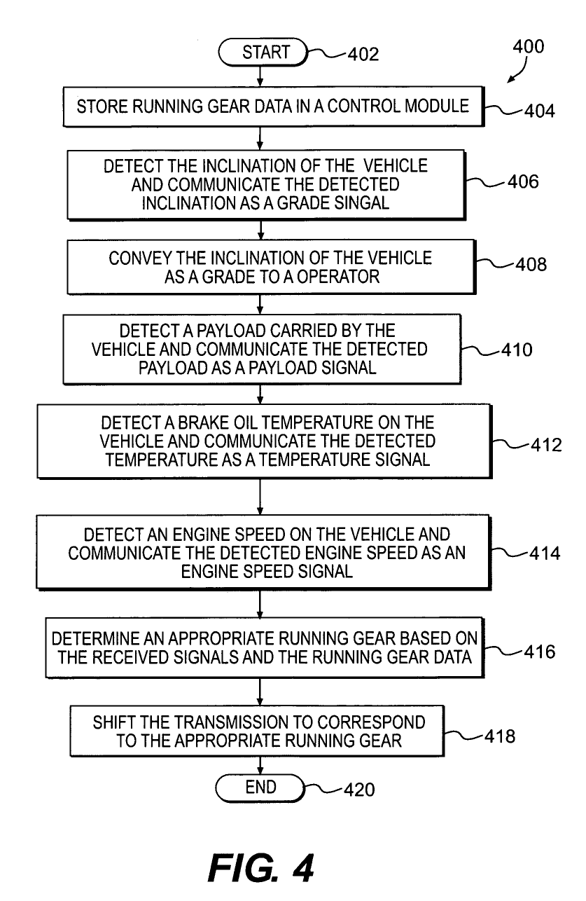

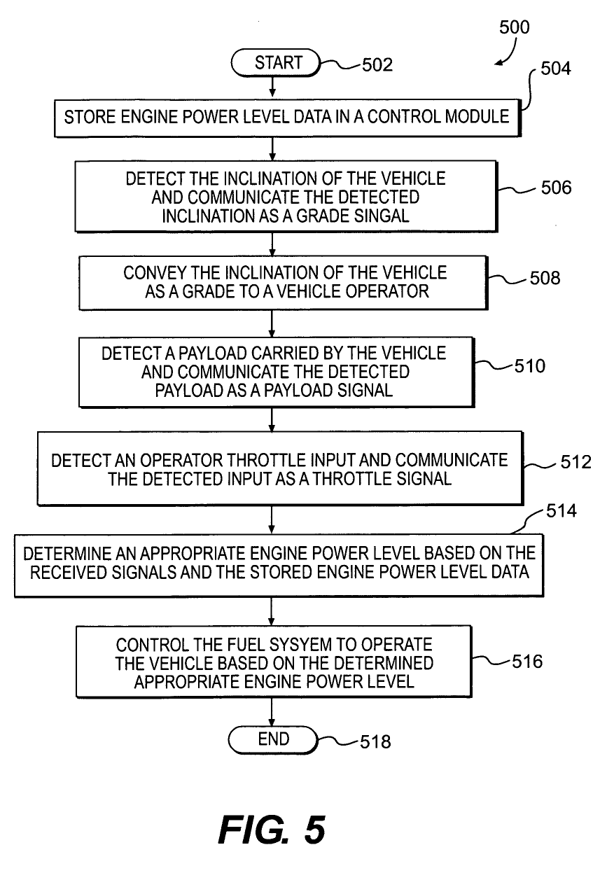

FIGS. 4 and 5 each describe methods of controlling the vehicle 100. The method of FIG. 4 is directed toward selecting an appropriate operating gear or running gear, while the method of FIG. 5 is directed toward selecting an appropriate engine power level. Although the two methods are disclosed separately, it should be apparent that they may be used together.

One exemplary method for controlling a running gear on a vehicle is disclosed in a flow chart 400 in FIG. 4. The flow chart 400 begins at a start step 402. At a step 404, running gear data is stored in the control module 204. The running gear data may include information such as an appropriate running gear for the vehicle, based upon one or more factors, including a grade being descended, the weight of the payload carried by the vehicle, the temperature of brake oil, and the engine speed. In one exemplary embodiment, the running gear data may be in the form of a look-up table, while in another, the running gear data is an algorithm configured to receive information and output a specific gear.

At a step 406, the inclinometer 216 detects an inclination of the vehicle 100 and communicates the detected inclination as a grade signal to the control module 204. The detected inclination may be indicative of a grade being traveled by the vehicle 100. The control module 204 may generate and send a display signal to the display 222 and, at a step 408, the display 222 may convey the inclination to a vehicle operator. The display 222 may be configured to convey the inclination as a grade that may be conveyed as a numeric value, as a percentage, as a picture, as a text message, or other visual or audible indicator.

At a step 410, the payload sensor 214 detects a payload carried by the vehicle 100 and communicates the detected payload as a payload signal to the control module 204. The payload sensor 214 may detect the payload by monitoring strut pressure or using other methods. In one exemplary embodiment, the detected payload may be communicated to the display 222 and may be viewed by an operator.

At a step 412, the oil temperature sensor 208 detects the brake oil temperature of the vehicle 100 and communicates the detected temperature as a temperature signal to the control module 204. At a step 414, the engine speed sensor 210 detects the speed of the engine and communicates the engine speed as an engine speed signal to the control module 204. The oil temperature and engine speed may also be displayed at the display 222.

At a step 416, the control module determines an appropriate gear based on the grade signal, the payload signal, the brake oil temperature signal, and/or the engine speed signal, as well as the stored running gear data. For example, if the vehicle is carrying a load of a certain weight over moderately level ground, then the control module 204 may select a first, relatively high running gear. Later, when the vehicle moves from the level ground onto a descending grade, the control module 204 may select a second, relatively lower running gear to retard the speed of the vehicle without an overly heavy reliance on the brakes. In addition, as the brake oil temperature increases, the control module 204 may select an even lower running gear to further retard the speed of the vehicle 100 to ease the reliance on the brakes. When the vehicle 100 reaches the end of the grade and is once again on level ground, the control module 204 may determine that a relatively higher running gear is appropriate. In one exemplary embodiment, the control module 204 also may control the shift point based on the payload weight and inclination of the vehicle 100. Accordingly, the control module 204 may adjust the shift point to a higher rpm when additional power is warranted, and may adjust the shift point to a lower rpm when less power is warranted.

At a step 418, the control module 204 generates and sends a transmission signal to the transmission 226 to shift the transmission 226 to correspond to the determined appropriate gear. At a step 420, the method ends. By automatically taking into account the incline, the payload, and/or other factors, operation of the vehicle 100 may be simplified because an appropriate operating gear may be selected without input from the operator. Further, the system may increase efficiency of the vehicle while reducing overall costs.

An exemplary method for controlling output power of the load-carrying vehicle is disclosed with reference to FIG. 5. The method 500 may begin at a step 502. At a step 504, engine power level data is stored in the memory component 220 of the control module 204. The engine power level data may include a power ratio between a throttle signal and the output power from the engine. The throttle signal may be communicated from the throttle sensor 212 based on the position of an associated input device, while the actual power output may be controlled, for example, through the fuel system 224. In this example, by controlling the fuel output relative to the throttle signal, the control module 204 may be configured to operate the vehicle 100 at various levels of horsepower. For example, the control module 204 may operate the vehicle at 1000 horsepower when traveling up a hill. Then, at the top of the hill, the engine power level data may indicate that the control module 204 can reduce the horsepower to a lower level, such as 900 horsepower. This reduction may be achieved by switching to a separate engine power level that may provide less fuel for the same throttle input.

At a step 506, the inclinometer 216 detects an inclination of the vehicle 100 and communicates the detected inclination to the control module 204 as a grade signal. At a step 508, the display 222 conveys information indicative of the grade to an operator, as discussed above. At a step 510, the payload sensor 214 detects a payload carried by the vehicle 100 and communicates the detected payload as a payload signal to the control module 204, as discussed above.

At a step 512, the throttle sensor 212 detects a throttle input from the operator and communicates the detected input as a throttle signal. The throttle signal may representative of a position of a pedal, lever, or other input device, and may be indicative of a requested amount of power from the engine.

At a step 514, based on the grade signal, the payload signal, and/or the throttle signal, in addition to the stored engine power level information, the control module 204 may automatically determine an appropriate engine power level for the vehicle 100. In one exemplary embodiment, the appropriate engine power level may control the output power by regulating fuel sent to the engine. Accordingly, for a given input, a relatively high amount of fuel may be fed to the engine, thereby generating a relatively high horsepower. This may be appropriate when the inclinometer 216 detects that the vehicle 100 is traveling uphill with a payload. In another exemplary embodiment, the appropriate engine power level may, for the same given input, send a relatively lower amount of fuel to the engine, thereby generating a relatively lower horsepower. This may be appropriate when the inclinometer 216 detects that the vehicle 100 is traveling across level ground, uphill with a payload less than nominal, or downhill. It should be noted that the memory component 200 may contain any number of engine power levels for different scenarios. In one exemplary embodiment, the engine power levels are look-up tables stored within the memory component 220.

At a step 516, the control module 204 generates a fuel signal based upon the determined engine power level and sends the fuel signal to the fuel system 224. The fuel system 224 then controls the vehicle 100 based on the determined engine power level. At a step 518, the method ends. By automatically taking into account the incline, the payload, and/or other factors, operation of the vehicle 100 may be simplified as an appropriate engine power level may be selected without input from the operator. Further, by ensuring that an appropriate engine power level is in use, the system may increase efficiency of the vehicle while reducing overall costs.

Although this method is disclosed with reference to a load-carrying vehicle such as an off-highway truck, it could be used on any vehicle, including an on-highway truck, an articulated truck, an off-highway tractor, or other work-machine. Furthermore, it should be apparent that the vehicle need not include both the operating gear data and the engine power level data, but may include either or, alternatively, both.

It will be apparent to those skilled in the art that various modifications and variations can be made in the disclosed embodiments without departing from the scope of the invention. Other embodiments of the invention will be apparent to those skilled in the art from consideration of the specification and practice of the invention disclosed herein. It is intended that the specification and examples be considered as exemplary only, with a true scope of the invention being indicated by the following claims and their equivalents.

What is claimed is:

1. A control system for a load-carrying vehicle, comprising:
a sensor configured to measure a parameter of the vehicle and communicate a sensor signal indicative of the measured parameter; and
a control module configured to receive the sensor signal from the sensor and determine an appropriate engine power level based on the sensor signal.

2. The control system of claim 1, wherein the sensor is a payload sensor configured to measure a payload weight carried by the vehicle.

3. The control system of claim 1, wherein the sensor is a grade detector configured to measure an inclination of the vehicle.

4. The control system of claim 3, wherein the grade detector continuously detects the inclination of the vehicle during operation of the vehicle.

5. The control system of claim 3, including a fuel system,
wherein the determined appropriate engine power level is configured to control the fuel system to use a relatively high amount of fuel when the vehicle is inclined upward based on the sensor signal, and
wherein the determined appropriate engine power level is configured to control the fuel system to use a relatively lower amount of fuel when the vehicle is inclined downward based on the sensor signal.

6. The control system of claim 1, wherein the sensor includes a payload sensor and a grade detector.

7. The control system of claim 1, wherein the engine power level includes a predefined ratio between a throttle signal and an output power from an engine of the vehicle.

8. The control system of claim 1, wherein the engine power level includes a predefined ratio between a throttle signal and an output power from an engine of the vehicle over a range of throttle signals.

9. The control system of claim 8, wherein the range is greater than half the range of possible throttle signals.

10. The control system of claim 8, wherein the range is over a substantially complete range of possible throttle signals.

11. The control system of claim 1, further including a display in communication with the control module, the display being viewable by an operator and configured to convey the measured parameter to a vehicle operator.

12. The control system of claim 1, including a throttle sensor associated with an operator input device, the throttle sensor being configured to communicate a throttle signal to the control module, wherein the control module is configured to determine the appropriate engine power level based on the throttle signal and the sensor signal.

13. The control system of claim 12, wherein the operator input device is one of a foot pedal and a hand-operated lever.

14. The control system of claim 1, wherein the control module is configured to determine an appropriate running gear based on the sensor signal, and configured to output a transmission signal to shift a gear to the determined appropriate running gear.

15. The control system of claim 14, including an oil temperature sensor configured to monitor a brake oil temperature and communicate an oil temperature signal indicative of the monitored brake oil temperature, the control module being configured to determine the appropriate running gear based on the oil temperature signal and the sensor signal.

16. The control system of claim 14, wherein the control module is configured to determine the appropriate running gear based on a lookup table stored within the control module.

17. The control system of claim 1, wherein the control module is configured to adjust a shift point based upon the sensor signal.

18. A method for controlling a load-carrying vehicle with a control system, comprising:
measuring a parameter of the vehicle;
communicating a sensor signal indicative of the measured parameter;
receiving the sensor signal at a control module; and
determining an appropriate engine power level with the control module based on the sensor signal.

19. The method of claim 18, wherein measuring a parameter of the vehicle includes detecting a payload weight carried by the vehicle.

20. The method of claim 18, wherein measuring a parameter of the vehicle includes monitoring an inclination of the vehicle.

21. The method of claim 20, wherein monitoring an inclination of the vehicle is continuously performed during operation of the vehicle.

22. The method of claim 20, including a fuel system, wherein determining an appropriate engine power level includes:
controlling a fuel system to use a relatively high amount of fuel when the vehicle is inclined upward based on the sensor signal; and
controlling the fuel system to use a relatively lower amount of fuel when the vehicle is inclined downward based on the sensor signal.

23. The method of claim 18, wherein measuring a parameter includes:
detecting a payload weight carried by the vehicle; and
monitoring an inclination of the vehicle.

24. The method of claim 18, wherein the engine power level includes a predefined ratio between a throttle signal and an output power from an engine of the vehicle.

25. The method of claim 18, wherein the engine power level includes a predefined ratio between a throttle signal and an output power from an engine of the vehicle over a range of throttle signals.

26. The method of claim 25, wherein the range is greater than half the range of possible throttle signals.

27. The method of claim 25, wherein the range is over a substantially complete range of possible throttle signals.

28. The method of claim 18, further including displaying the measured parameter to a vehicle operator.

29. The method of claim 18, including:
communicating a throttle signal to the control module representative of a command at an input device; and
determining the appropriate engine power level based on the throttle signal and the sensor signal.

30. The method of claim 18, including:
determining an appropriate running gear based on the sensor signal; and
outputting a transmission signal to shift a gear to the determined appropriate running gear.

31. The method of claim 30, including:
monitoring a brake oil temperature and communicating an oil temperature signal indicative of the monitored brake oil temperature; and
determining the appropriate running gear based on the oil temperature signal and the sensor signal.

32. The method of claim 30, wherein determining the appropriate running gear includes using a lookup table stored within the control module.

33. The method of claim 18, including adjusting a shift point based upon the sensor signal.

34. A control system for a load-carrying vehicle, comprising:
a grade detector configured to detect an inclination of the vehicle and communicate a grade signal based on the inclination of the vehicle;
a payload sensor configured to detect a payload weight carried by the vehicle and to communicate a payload signal indicative of the payload weight; and
a control module configured to receive the grade signal from the grade detector and receive the payload signal from the payload sensor and determine an appropriate running gear based on the grade signal and the payload signal.

35. The control system of claim 34, wherein the grade detector continuously detects the inclination of the vehicle during operation of the vehicle.

36. The control system of claim 34, wherein the control module is configured to output a transmission signal to shift a gear to the determined appropriate running gear.

37. The control system of claim 34, including an oil temperature sensor configured to monitor a brake oil temperature and communicate an oil temperature signal indicative of the monitored brake oil temperature, the control module being configured to determine the appropriate running gear based on the oil temperature signal.

38. The control system of claim 34, wherein the engine power level includes a predefined ratio between a throttle signal and an output power from an engine of the vehicle over a range of throttle signals.

39. A load-carrying vehicle, comprising:
a grade detector configured to detect the inclination of the vehicle and communicate a grade signal based on the inclination of the vehicle;
a payload sensor configured to detect a payload weight carried by the vehicle and to communicate a payload signal indicative of the payload weight;
a fuel system configured to send fuel to power the vehicle; and
a control module configured to receive the grade signal from the grade detector and the payload signal from the payload sensor and determine an appropriate engine power level based on the grade and payload signals, wherein the engine power level includes a predefined ratio between throttle position and an amount of fuel sent to an engine of the vehicle over a range of throttle signals, and wherein the control module is configured to send a fuel signal to control the fuel system.

40. The load-carrying vehicle of claim 39, including:
a transmission configured to shift between running gears; and
a control module configured to determine an appropriate running gear based on the grade signal and the payload signal, the control module being configured to generate and output a transmission signal to the transmission to control a running gear.

41. The load-carrying vehicle of claim 39, wherein the grade detector continuously detects the inclination of the vehicle during operation of the vehicle, and wherein the payload sensor continuously detects the payload weight carried by the vehicle during operation of the vehicle.

42. The load-carrying vehicle of claim 39, including an oil temperature sensor configured to monitor a brake oil temperature and communicate an oil temperature signal indicative of the monitored brake oil temperature, the control module being further configured to determine the appropriate running gear based on the oil temperature signal.

43. The load-carrying vehicle of claim 39, including:
a foot pedal configured as a throttle to operate the vehicle; and
a throttle sensor associated with the foot pedal, the throttle sensor being configured to communicate a throttle signal to the control module, wherein the control module is configured to determine the appropriate engine power level based on the throttle signal.

44. The load-carrying vehicle of claim 39, wherein the control module is configured to adjust a shift point based upon at least one of the grade signal and the payload signal.

45. The load-carrying vehicle of claim 39, wherein the grade detector is one of an inclinometer and a GPS receiver.
